(19) United States
(12) Patent Application Publication
(10) Pub. No.: US 2006/0005706 A1
(43) Pub. Date: Jan. 12, 2006

(54) Electro-optical air sterilizer with ionizer

(76) Inventor: Se Kit Yuen, Hong Kong (CN)

Correspondence Address: ARTHUR KING MA, 1030 CORONADO DRIVE, ARCADIA, CA, 91007, US

(21) Appl. No.: 10/888,130

(22) Filed: Jul. 9, 2004

(51) Int. Cl. B03C 3/38

(52) U.S. Cl. 96/16

(57) ABSTRACT

This invention relates to an air purifier that uses both transportation vehicles battery and conventional indoor power supply, employs ultraviolet radioactive rays to kill bacteria, viruses and molds in the air and to increase the amount of anions. This air purifier works with any air conditioners or machines of all sizes, at exhaust inlet or outlet, as well as inside the surface shield or outside of air conditioning devices and dehumidifiers and electric fans of all sizes. This air purifier draws indoor air in and out of the air purifier, kills bacteria, viruses and moulds in the air and discharges electricity by means of negative high voltage output through carbon fibers to produce anions, so as to improve the quality of the air.

### BACKGROUND OF THE PRESENT INVENTION

The present invention relates to air purifiers, more particularly, it relates to air purifiers employ ultraviolet radioactive rays to eliminate bacteria, viruses and molds in the air and to increase the amount of anions in an environment which also compatible with all air conditioning systems and all air circulation or ventilation system.

1. Field of Invention

Air purifies are commonly used in nowadays. Especially problems of air pollution are getting worst as our society has become more industrialize, more depending on transportation vehicles, and more diseases are transmitted by air.

Most conventional air purifiers require normal indoor power supply such as 220V or 120 volt depending on geographical limitation, while few of those are designed mainly for transportation vehicles, which allow air purifier to function under a power supply generated by automobile, i.e. 12 volt, as transportation vehicles are operating. Almost no conventional air purifier has the ability providing capacity for both indoor power supply and automobile power supply.

Moreover, most conventional air purifiers are designed to function as an independent unit without any ability or compatibility to work with any air conditioning system or to any ventilation system simultaneously. Therefore, when air purification is expected, consumers are required to purchase air purifiers separately in addition to their existing air conditioning or ventilation systems.

Worsen still; most conventional air purifiers can only separate unwanted airborne particles from air to achieve so-called purification for air. However, this is a well known fact that anions in the air are good for health. It would be beneficial should air purifiers can produce anions while separating unwanted airborne particles from air allows.

2. Description of Related Arts

### SUMMARY OF THE PRESENT INVENTION

A main object of the present invention is to provide an air purifier has the ability providing capacity for both indoor power supply and automobile power supply.

Another object of the present invention is to provide an air purifier has ability or compatibility to work with any air conditioning system or to any ventilation system simultaneously.

Another object of the present invention is to provide an air purifier can produce anions while separating unwanted airborne particles from air flows. Accordingly, in order to accomplish the above objects, the present invention provides an air purifier, which comprises:

a three dimensional housing and inlet and outlet bars, which is mounted to the front plane of said body, and

an inlet frame grid is mounted to a front plane portion of frame grid, and

an ultraviolet radioactive ray chamber is located within a triangle in a center position of a filter frame grid, and

a contact chips at both front and rear portions of ultraviolet radioactive ray chamber are connecting to an external power via terminal box, while said ultraviolet radioactive ray chamber fastens a front frame grid and an rear frame grid in a half-circle, and

a carbon fibers are fastened within an extended pit of a front frame grid, and

a front frame grid further comprises

a circuit board, electronic components, and external power line.

On a side face of a front frame grid, there is a rectangular hole-site which fastens said external power line. A switch is connected to a central section of said external power line.

In actual operation, this air purifier is usually installed at an exhaust inlet/outlet, within an external shield or outsides of an air conditioning device. The indoor air aspirated enters said front frame grid through said inlet frame grid, passes said central triangle in said filter frame grid, and is deprived of bacteria, viruses and molds by ultraviolet radioactive rays emitted from said ultraviolet radioactive ray chamber. Then fresh and clean air goes out of said rear frame grid through said outlet frame grid to enter said air conditioning device via said inlet, and discharges from said outlet of said air conditioning device. Thus the quality of indoor air environment is improved.

This invention involves an air purifier, and related to an air purifier that uses not only automobile battery but also conventional indoor power supply, and uses ultraviolet radioactive rays to kill bacteria, viruses and moulds in the air and to increase the amount of anions in the environment. This air purifier can be installed in any air conditioners or machines of all sizes, at exhaust inlet or outlet, as well as inside the surface shield or outside of air conditioning devices. In actual operation, this air purifier draws indoor air in and out of the air purifier, kills bacteria, viruses and moulds in the air and discharges electricity by means of negative high voltage output through carbon fibers to produce anions, so as to improve the quality of the air. This air purifier can also be installed in dehumidifiers and electric fans of all sizes. Once indoor air is drawn in or discharged out of the dehumidifier or the electric fan, it moves into the air purifier, which eliminates bacteria, viruses and moulds in the air, and discharges electricity by means of negative high voltage output through carbon fibers to produce anions.

### BRIEF DESCRIPTION OF THE DRAWINGS

FIG. 1 is a space diagram of the present invention.

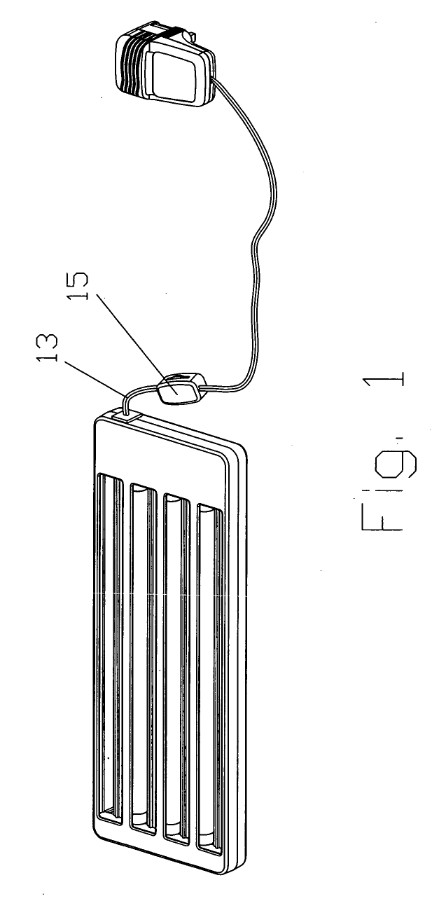

FIG. 2 is a structural instruction of the present invention.

FIG. 3 is a front view of the present invention.

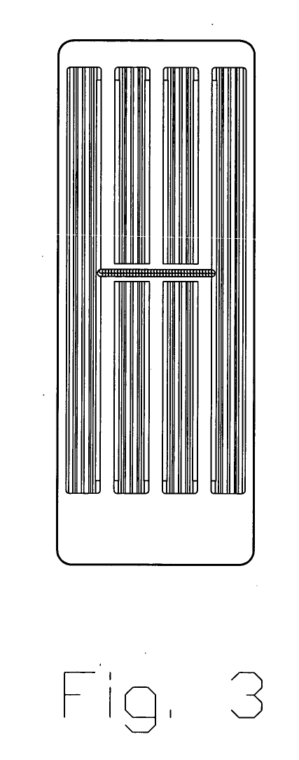

FIG. 4 is a vertical sectional view of the present invention.

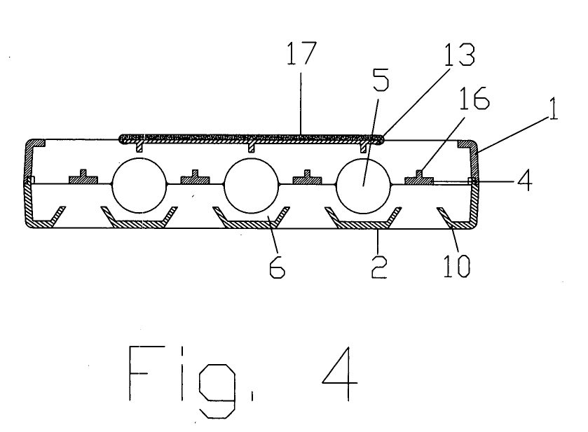

FIG. 5 is a side view of the present invention.

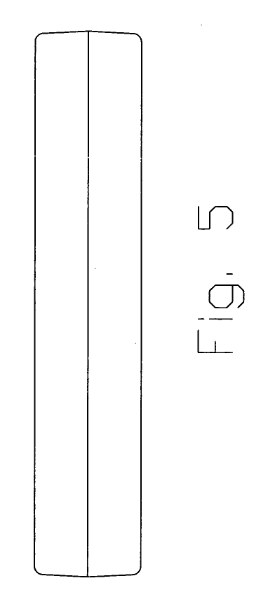

FIG. 6 is another side view of the present invention.

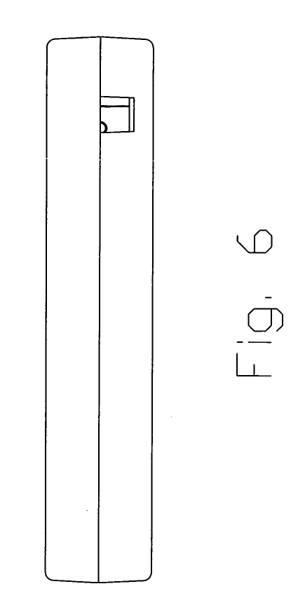

FIG. 7 is a top view of the present invention

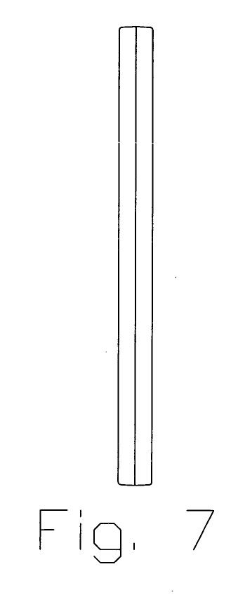

FIG. 8 is a underneath view of the present invention.

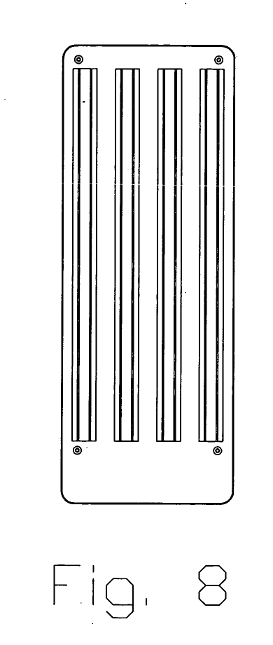

### DETAILED DESCRIPTION OF THE PREFERRED EMBODIMENT

The present invention comprises of three dimensional housing (1) and inlet and outlet bars (3), which is mounted to the front plane of said body (1). The air deprived of bacteria, viruses and molds by a photoelectric device becomes clean air and enters an exhaust inlet and/or outlet of an air conditioning through frame grid (3).

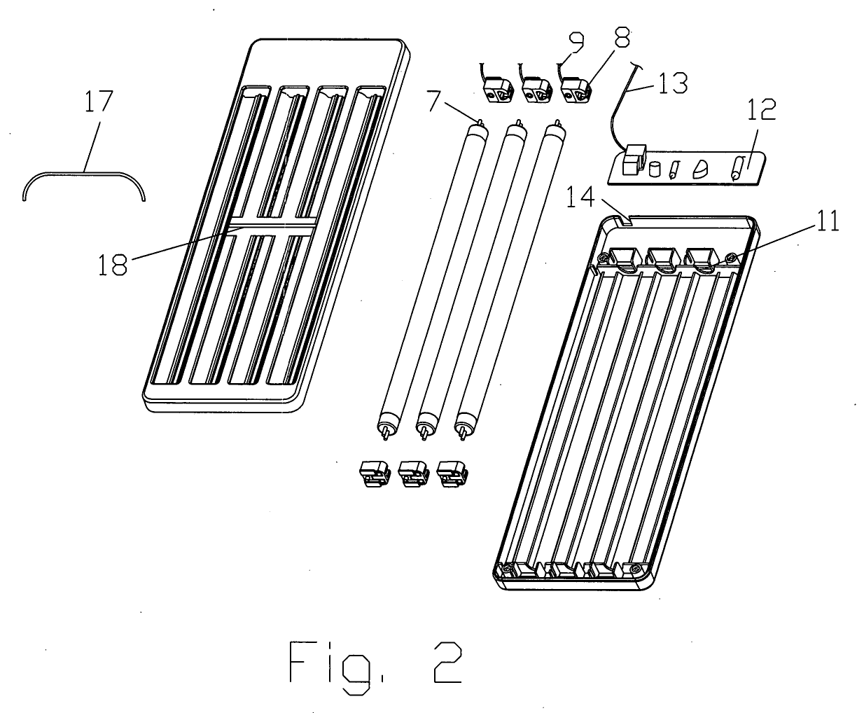

Referring to FIG. 2 for detailed structure air purifier, inlet frame grid (2) is mounted to a front plane portion of frame grid (10). On air filter frame grid (4) that is usually made of rubber or metal material and shaped in rectangular structure, there are many stripe grids 16 that enable penetration of air through said grids. Since said filter frame grid (4) is composed of multiple stripe grids, air can easily enter and pass through said air filter frame grid (4) to reach exhaust outlet frame grid (3). An ultraviolet radioactive ray chamber (5) is located within a triangle (6) in a center position of said filter frame grid (4). A contact chips (7) at both front and rear portions of said ultraviolet radioactive ray chamber (5) are connecting to an external power (9) via terminal box (8), while said ultraviolet radioactive ray chamber (5) fastens said front frame grid (10) and an rear frame grid (1) in a half-circle (11). Carbon fibers are fastened within an extended pit (18) of said front frame grid (10).

Front frame grid (10) provides a place to fasten a circuit board, electronic components (12), and external power line (13).

On a side face of said front frame grid (10), there is a rectangular hole-site (14) which fastens said external power line (13). A switch (15) is connected to a central section of said external power line (13).

In actual operation, this air purifier is usually installed at an exhaust inlet/outlet, within an external shield or outsides of an air conditioning device. The indoor air aspirated enters said front frame grid (10) through said inlet frame grid (2), passes said central triangle (6) in said filter frame grid (4), and is deprived of bacteria, viruses and molds by ultraviolet radioactive rays emitted from said ultraviolet radioactive ray chamber (5). Then fresh and clean air goes out of said rear frame grid (1) through said outlet frame grid (3) to enter said air conditioning device via said inlet, and discharges from said outlet of said air conditioning device. Thus the quality of indoor air environment is improved.

The present invention, air purifier generates ultraviolet rays with wavelength ranges at 253.7 nanometers from its ultraviolet radioactive ray chamber to effectively kill bacteria and viruses. In modern society, air conditioner has become a must device for most families, hospitals, senior citizen centers, department stores, cinemas, restaurants, offices, plants, as well as elevators, transportation vehicles, vessels, airplanes and railways of all sizes. The combination of air purifier and air conditioner will endow new functions to air conditioner, and eventually improve living, residential, medical, work, consumption environment and means of communication, and regain a clean space for the human being although the natural environment is constantly destroyed by the modern society.

What is claimed is:

1. An air purifier comprises:
a three dimensional housing and inlet and outlet bars, which is mounted to the front plane of said body, and
an inlet frame grid is mounted to a front plane portion of frame grid, and
an ultraviolet radioactive ray chamber is located within a triangle in a center position of a filter frame grid, and
a contact chips at both front and rear portions of ultraviolet radioactive ray chamber are connecting to an external power via terminal box, while said ultraviolet radioactive ray chamber fastens a front frame grid and an rear frame grid in a half-circle, and
a carbon fibers are fastened within an extended pit of a front frame grid, and
anion-generating circuit, and
a front frame grid further comprises
a circuit board, electronic components, and external power line.
On a side face of a front frame grid, there is a rectangular hole-site which fastens said external power line. A switch is connected to a central section of said external power line.

2. An air purifier comprises:
a three dimensional housing, and
at least one set of circuit board, and
at least one anion-generating circuit,
at least one switch,
at least one ultraviolet radioactive ray chamber, and
one air filter frame grid made of rubber or metal material and shaped in rectangular structure,
and one power input line.

3. An ultraviolet radioactive ray chamber produces 253.7 nanometers of waves to active an electronic circuit.

4. An electronic circuit as recited in claim 1, is distinguished by its negative high voltage output value between 4.5 kv to 8.5 kv.

5. An electronic circuit as recited in claim 2, is distinguished by its negative high voltage output value between 4.5 kv to 8.5 kv

6. An electronic circuit mentioned in claim 1 is distinguished by the function of the variable resistor effect created by the anion-generating circuit is to adjust negative high voltage output value.

7. An electronic circuit mentioned in claim 2 is distinguished by the function of the variable resistor effect created by the anion-generating circuit is to adjust negative high voltage output value.

8. An electronic circuit mentioned in claim 1 is distinguished by the function of the variable resistor effect created by the circuit-activating 253.7-nanometer rays produced by the ultraviolet radioactive ray chamber is to adjust negative high voltage output value.

9. An electronic circuit mentioned in claim 2 is distinguished by the function of the variable resistor effect created by the circuit-activating 253.7-nanometer rays produced by the ultraviolet radioactive ray chamber is to adjust negative high voltage output value.

10. An air purifier as recited in claim 1, wherein said air purifier can adapt both conventional indoor power supply and power generated by any transportation vehicles.

11. An air purifier as recited in claim 2, wherein said air purifier can adapt both conventional indoor power supply and power generated by any transportation vehicles.

12. An air purifier as recited in claim 1, wherein said air purifier is having the ability and compatibility to work with any air conditioning system or to any ventilation system simultaneously.

13. An air purifier as recited in claim 2, wherein said air purifier is having the ability and compatibility to work with any air conditioning system or to any ventilation system simultaneously.

14. An air purifier as recite in claim 1, a three dimensional housing and inlet and outlet bars, which is mounted to the front plane of said body, and
an inlet frame grid is mounted to a front plane portion of frame grid, and
an ultraviolet radioactive ray chamber is located within a triangle in a center position of a filter frame grid, and
a contact chips at both front and rear portions of ultraviolet radioactive ray chamber are connecting to an external power via terminal box, while said ultraviolet radioactive ray chamber fastens a front frame grid and an rear frame, grid in a half-circle, and
a carbon fibers are fastened within an extended pit of a front frame grid, and
a front frame grid further comprises
a circuit board, electronic components, and external power line.
On a side face of a front frame grid, there is a rectangular hole-site which fastens said external power line. A switch is connected to a central section of said external power line.
In actual operation, this air purifier is usually installed at an exhaust inlet/outlet, within an external shield or outsides of an air conditioning device. The indoor air aspirated enters said front frame grid through said inlet frame grid, passes said central triangle in said filter frame grid, and is deprived of bacteria, viruses and molds by ultraviolet radioactive rays emitted from said ultraviolet radioactive ray chamber. Then fresh and clean air goes out of said rear frame grid through said outlet frame grid to enter said air conditioning device via said inlet, and discharges from said outlet of said air conditioning device.

15. An air purifier as recite in claim 2, a three dimensional housing and inlet and outlet bars, which is mounted to the front plane of said body, and
an inlet frame grid is mounted to a front plane portion of frame grid, and
an ultraviolet radioactive ray chamber is located within a triangle in a center position of a filter frame grid, and
a contact chips at both front and rear portions of ultraviolet radioactive ray chamber are connecting to an external power via terminal box, while said ultraviolet radioactive ray chamber fastens a front frame grid and an rear frame grid in a half-circle, and
a carbon fibers are fastened within an extended pit of a front frame grid, and
a front frame grid further comprises
a circuit board, electronic components, and external power line.
On a side face of a front frame grid, there is a rectangular hole-site which fastens said external power line. A switch is connected to a central section of said external power line.
In actual operation, this air purifier is usually installed at an exhaust inlet/outlet, within an external shield or outsides of an air conditioning device. The indoor air aspirated enters said front frame grid through said inlet frame grid, passes said central triangle in said filter frame grid, and is deprived of bacteria, viruses and molds by ultraviolet radioactive rays emitted from said ultraviolet radioactive ray chamber. Then fresh and clean air goes out of said rear frame grid through said outlet frame grid to enter said air conditioning device via said inlet, and discharges from said outlet of said air conditioning device.

16. The electronic circuit system that aims at improving certain features of the air environment is especially applicable for increasing the amount of anions and purifying air indoors, and is characterized by:
Anion-generating circuit and
an ultraviolet radioactive ray chamber produces 253.7 nanometers of waves to active the circuit.

17. An air purifier as recited in claim 1 or 2, wherein said air purifier can hold a position inside or outside of air conditioners of all sizes, outside of dehumidifiers and electric fans of all sizes, exhaust inlet and outlet, as well as within the external shield or outside of air conditioning devices.

18. An air purifier as recited in claim 1 or 2, wherein said air purifier can discharge at negative high voltage output via carbon fibers, and produces anions to eject into the air.

19. An air purifier as recited in claim 1 or 2, wherein said air purifier has an ability for emission of ultraviolet radioactive rays and a an ability to discharges electricity by means of negative high voltage output through carbon fibers to produce anions, said emission and discharging can function separately or simultaneously.
